(19) United States
(12) Patent Application Publication
(10) Pub. No.: US 2008/0076954 A1
(43) Pub. Date: Mar. 27, 2008

(54) Ultrasound-induced destruction of trace-level estrogen hormones in aqueous solutions

(76) Inventors: Rominder P.S. Suri, Audubon, PA (US); Hongxiang Fu, Devon, PA (US); Mohan Somanath Nayak, Devon, PA (US)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(21) Appl. No.: 11/526,172

(22) Filed: Sep. 22, 2006

(51) Int. Cl. A62D 3/13

(52) U.S. Cl. 588/304

(57) ABSTRACT

A method for effectively degrading and destroying many pharmaceutical and personal care compounds in aqueous solutions. The method includes providing an aqueous solution containing at least one pharmaceutical or personal care compound (e.g., estrogene hormone, antibiotics, and the like) to a reactor. A source of ultrasound is provided having a predetermined energy and intensity. The aqueous solution is sonicated in the reactor to degrade and destroy the at least one pharmaceutical or personal care compound. Further provided is a related method for degrading and destroying many pharmaceutical and personal care pollutants in aqueous sludge while simultaneously enhancing the biodegradability and dewaterability of the aqueous sludge. Still further provided is a related method for predicting the first order ultrasound-induced degradation rate constant of any estrogen compound present in an aqueous solution based on the rate constant of estrone.

### TECHNICAL FIELD

The present invention relates generally to water purification and, more particularly, to the degradation and destruction of pharmaceutical active compounds, especially estrogen hormones and antibiotics, in aqueous solutions.

### BACKGROUND OF THE INVENTION

Pharmaceutical active compounds (PACs), such as estrogen hormones and antibiotics, are pollutants that have received much attention in recent years. These compounds have been detected in noteworthy concentrations in surface water, wastewater, soil, sediments, animal manure, and groundwater. See, for example, B. Halling-Sorensen et al., “Occurrence, fate and effects of pharmaceutical substances in the environment—a review,” Chemosphere, 36(2), pp. 357-93 (1998); D. Kolpin et al., “Pharmaceuticals, hormones, and other organic wastewater contaminants in U.S. streams, 1999-2000: a national reconnaissance,” Environmental Science and Technology, 36, pp. 1202-11 (2002); S. Rodriguez-Mozaz et al., “Monitoring of estrogens, pesticides and bisphenol A in natural waters and drinking water treatment plants by solid-phase extraction—liquid chromatography—mass spectrometry,” Journal of Chromatography, A. 1045, pp. 85-92 (2004); M. Kuster et al., “Analysis and distribution of estrogens and progestogens in sewage sludge, soils and sediments,” Trends in Analytic Chemistry, 23, pp. 790-98 (2004); and R. Chimchirian et al., “Presence of low-level free steroid estrogens in the surface water,” International Conference on Energy, Environment and Disasters (INCEED 2005) (Charlotte, N.C., USA, July, 2005). They are either produced naturally in the body (such as natural hormones) or are synthetically created (such as synthetic hormones and antibiotics) for pharmaceutical use by human beings, animals, and aquaculture.

PACs leave homes in the waste and travel to municipal wastewater treatment plants. They are also present in wastewaters from pharmaceutical production facilities. Thus, the pharmaceutical pollutants can enter the aquatic environment from, among other sources, discharge of municipal wastewater effluent, septic tanks, and runoff from animal manure application areas.

Because these chemical compounds cannot be completely removed at conventional wastewater treatment plants, they end up in the environment and pollute such natural resources as surface waters. There are many reports documenting this pass-through aspect from wastewater treatment plants and the presence of pharmaceuticals in the environment. There are many reports, too, on the adverse effects of pharmaceuticals in aqueous systems on aquatic organisms such as fish.

As one specific example, feminization of male fish has been observed in the United States, Europe, and other parts of the world. Estrogen hormones interfere with reproductive systems by producing an unnatural response of the endocrine system. Estrogenic effects have been observed in “vivo” studies with fish at concentrations as low as 0.1 ng/L for ethinyl estradiol. See E. Routledge et al., “Identification of estrogenic chemicals in STW effluent. 2. In vivo responses in trout and roach,” Environmental Science and Technology, 32, pp. 1559-65 (1998). With quantitative risk assessment on such species as daphni, algae, and fish, investigators found that sex hormones show their highest relative toxicity in four classes of pharmaceuticals: antibiotics, antineoplastics, cardiovascular, and sex hormones. See H. Sanderson et al., “Toxicity classification and evaluation of four pharmaceuticals classes: antibiotics, antineoplastics, cardiovascular, and sex hormones,” Toxicology, 203, pp. 27-40 (2004). The removal of PACs from water and wastewater is of importance due to their adverse ecological effects and potential risks to human health.

Many studies show that wastewater treatment effluent is one of the major pollution sources of estrogen hormones to ecosystems. See, for example, R. Chimchirian et al., “Free synthetic and natural estrogen hormones in influent and effluent of three municipal wastewater treatment plants,” to be published on Water Science Research [accepted for publication]; J. Pedersen et al., “Human pharmaceuticals, hormones, and personal care product ingredients in runoff from agricultural fields irrigated with treated wastewater,” Journal of Agricultural and Food Chemistry, 53, pp. 1625-32 (2005); and C. Tyler et al., “Accounting for differences in estrogenic responses in rainbow trout (oncorhynchus mykiss: salmonidae) and roach (rutilus rutilus: cyprimidae) exposed to effluents from wastewater treatment works,” Environmental Science and Technology, 39, pp. 2599-2607 (2005). The estrogen compounds are not totally removed in conventional biological wastewater treatment processes. Rather, detectable concentrations are discharged from treatment plants and observed in the receiving water body. See, for example, H. Andersen et al., “Fate of estrogens in a municipal sewage treatment plant,” Environmental Science and Technology, 37(18), pp. 4021-26 (2003) (later, “H. Andersen et al., ‘Fate’”); and A. Johnson et al., “Critical review—Removal of endocrine-disrupting chemicals in activated sludge treatment works,” Environmental Science and Technology, 35(24), 4697-4703 (2001) (later, “A. Johnson et al., ‘Critical Review’”). Although the operational conditions (such as hydraulic retention time, sludge retention time, and dissolved oxygen concentration) of the treatment processes could be adjusted to obtain optimized degradation of the PACs, the efficient removal of most of the toxic estrogens is still a question. See T. Ternes et al., “Scrutinizing pharmaceuticals and personal care products in wastewater treatment,” Environmental Science and Technology, 38, pp. 393A-399A (2004). It has also been reported that trace amounts of pharmaceuticals present in drinking water sources resist removal during conventional drinking water treatment operations such as coagulation, sedimentation, flocculation, and filtration. See P. Stackelberg et al., “Persistence of pharmaceutical compounds and other organic wastewater contaminants in a conventional drinking-water-treatment plant,” Science of Total Environment, 329, 99-113 (2004).

The presence of PACs such as estrogen compounds in natural systems leads to the necessity of developing effective treatment techniques, either as a supplement for conventional drinking water treatment systems to prevent potential adverse human health effects, or for conventional municipal and industrial wastewater treatment processes to decrease the pollution of PACs in the natural systems. Recently, a number of different physical-chemical and biological treatment processes have been studied and reported in publications for removal of PACs from drinking water and municipal wastewater: (1) ozonation, (2) chlorination, (3) adsorption, (4) photocatalysis, and (5) conventional activated sludge treatment processes. For a discussion of ozonation methods, see M. Huber et al., “Oxidation of pharmaceuticals during ozonation of municipal wastewater effluents: a pilot study,” Environmental Science and Technology, 39(11), pp. 4290-99 (2005) (later, “M. Huber et al., Pilot Study’”); M. Huber et al., “Oxidation of Pharmaceuticals during Ozonation and Advanced Oxidation Processes,” Environmental Science and Technology, 37(5), pp. 1016-24 (2003); T. Ternes et al., “Ozonation: a tool for removal of pharmaceuticals, contrast media and musk fragrances from wastewater?”, Water Research, 37(8), pp. 1976-82 (2003); and P. Westerhoff et al., “Fate of endocrine-disruptor, pharmaceutical, and personal care product chemicals during simulated drinking water treatment processes,” Environmental Science and Technology, 39(17), pp. 6649-63 (2005).

For a discussion of chlorination methods, see M. Huber et al., “Oxidation of pharmaceuticals during water treatment with chlorine dioxide,” Water Research, 39(15), pp. 3607-17 (2005). For a discussion of adsorption methods, see T. Fukuhara et al., “Adsorbability of estrone and 17 beta-estradiol in water onto activated carbon,” Water Research, 40, pp. 241-48 (2006); J. Rudder et al., “Advanced water treatment with manganese oxide for the removal of 17[alpha]-ethynylestradiol (EE2),” Water Research, 38(1), pp. 184-92 (2004); and Y. Zhang et al., “Removal of estrone and 17β-estradiol from water by adsorption,” Water Research, 39(16), pp. 3991-4003 (2005). For a discussion of photocatalysis methods, see Y. Ohko et al., “17b-estradiol degradation by TiO₂ photocatalysis as a means of reducing estrogenic activity,” Environmental Science and Technology, 36(19), pp. 4175-81 (2002); and H. Coleman et al., “Rapid loss of estrogenicity of steroid estrogens by UVA photolysis and photocatalysis over an immobilised titanium dioxide catalyst,” Water Research, 38(14-15), pp. 3233-40 (2004). Finally, for a discussion of conventional activated sludge treatment processes, see A. Johnson et al., “Critical Review”; A. Joss et al., “Removal of Estrogens in Municipal Wastewater Treatment under Aerobic and Anaerobic Conditions: Consequences for Plant Optimization,” Environmental Science and Technology, 38(11), pp. 3047-55 (2004); A. Layton et al., “Mineralization of Steroidal Hormones by Biosolids in Wastewater Treatment Systems in Tennessee U.S.A.,” Environmental Science and Technology, 34(18), pp. 3925-31 (2000); and H. Andersen et al., “Fate.”

Each of these processes known in the art is expensive, ineffective in destroying most PACs, or both. The effectiveness of these processes is greatly reduced by other dissolved species in wastewaters. Moreover, most of these processes are based on the addition of oxidant chemicals such as chlorine, ozone, or other materials such as adsorbents. The ozonation and chlorination processes require the addition of ozone or chlorine to the system and have limited effectiveness. Ozone needs to be produced on-site and after water treatment the excess ozone in the off-gas or that dissolved in the water has to be removed or destroyed. In addition, this process is difficult to use and requires extensive control measures.

Biological processes result in the production of sludge (also called bio-solids). With the adsorption process, the pharmaceutical pollutants are simply transferred to the solid medium, i.e., sludge, which generates hazardous waste. Reports indicate that estrogens are present in the sludge. The sludge is typically land-applied as a common disposal practice. The sludge poses an environmental risk, however, due to the presence of estrogens, which can leach and contaminate groundwater and surface water. Hence, the conventional biological treatment processes are not suitable for the removal of estrogen compounds present in wastewater.

Conventional activated sludge treatment has been shown to degrade certain pharmaceuticals and estrogen compounds to varying extents, ranging from complete to very poor degradation. Applying longer sludge retention times results in partly improved degradation, but most of the investigated compounds cannot be completely degraded. See M. Huber et al., “Pilot Study.” Field data suggest that the activated sludge treatment process can remove over 85% of estradiol, estriol, and ethinyl estradiol. The removal performance for estrone appears to be less, however, and is more variable. See A. Johnson et al., “Critical Review.”

Ultrasound (also referred to as sonolysis) is sound with a frequency greater than the upper limit of human hearing, this limit being approximately 20 kilohertz (20,000 hertz). Sonography (ultrasonography) is a useful ultrasound-based technique that has multiple applications. Ultrasound is perhaps best known as a diagnostic medical imaging technique. Ultrasound is also used, however, in industry to find flaws in materials or as a flow meter. Ultrasound cleaners use ultrasound (usually from 20-40 kHz) to clean delicate items such as jewelry, lenses and other optical parts, coins, watches, dental and surgical instruments, fountain pens, industrial parts and electronic equipment. Sonochemistry is another application of ultrasound. Among other applications for ultrasound are sonic weaponry and range finding (a use also called sonar).

Most relevant to the present invention, ultrasound has been shown to be an effective advanced water treatment technology for destruction of many toxic organic chemicals. See, for example, Y. Adewuyi, “Sonochemistry: Environmental science and engineering application,” Industrial Engineering Chemical Research, 40, pp. 4681-4715 (2001) (later, “Y. Adewuyi, ‘Sonochemistry: Environmental Science’”); M. Hoffmann et al., “Application of ultrasonic irradiation for the degradation of chemical contaminants in water,” Ultrasonic Sonochemistry, 3, pp. S163-S172 (1996) (later, “M. Hoffmann et al., ‘Application of Ultrasonic Irradiation’”); R. Suri et al., “Effect of Process Variables On Sonochemical Destruction of Aqueous Trichloroethylene,” Environmental Engineering Science, 16, pp. 345-51 (1999); and P. Cyr et al., “Sonochemical Destruction of Trichloroethylene in Water,” Water Science and Technology, 40, pp. 131-36 (1999). In this method, the contaminated solution is irradiated with sound waves generated from an ultrasound source. When the sound waves pass through the liquid, they create cavities due to oscillating acoustic pressures. The dissolved gases, organic compounds, and water vapor can diffuse into the cavities from bulk solution. These cavities grow in size and ultimately implode, generating temperatures as high as 5200° K and pressures higher than 1000 atm inside the collapsing cavity, and about 1900° K in the interfacial region between the solution and the collapsing bubble. See K. Suslick et al., “The Sonochemical Hot Spot,” Journal of American Chemical Society, 108, pp. 5641-42 (1986).

The destruction of organic pollutants occurs via several mechanisms. The organic pollutant inside the cavity and in the interfacial region (cavity-liquid) can undergo pyrolytic or thermal degradation reactions (or combustion reactions if oxygen is present during the implosion). Y. Adewuyi, “Sonochemistry: Environmental Science”; M. Hoffmann et al., “Application of Ultrasonic Irradiation.” Another mechanism is that free radicals (OH., H., HO₂.) formed due to thermolysis of water molecules can react with the organics in the interfacial region or in the bulk solution near the interface. See M. Hoffmann et al., “Application of Ultrasonic Irradiation”; J. Peller et al., “Sonolysis of 2,4-Dichlorophenoxyacetic acid in aqueous solutions. Evidence for OH-radical-mediated degradation,” Journal of Physical Chemistry, A. 105, pp. 3176-3181 (2001).

The sonolysis process is not limited to the toxicity and low-biodegradability of pollutant compounds. The chemicals are mineralized or degraded to smaller molecules with improved biodegradability or lower toxicity. In addition, the sonolysis effects could be promoted if combined with other oxidants such as ozone or H₂O₂. Y. Adewuyi, “Sonochemistry in environmental remediation. 1. combinative and hybrid sonophotochemical oxidation processes for the treatment of pollutants in water,” Environmental Science and Technology, 39, pp. 3409-20 (2005).

To overcome the shortcomings of existing conventional water purification techniques, a new method is provided. An object of the present invention is to provide an improved, economical method for effectively degrading and destroying many pharmaceutical and personal care compounds in aqueous solutions. Another object is to provide a method that does not require any chemical additives, any pH adjustment, or any filtration. A related object is to provide a method that is relatively simple to use, avoiding hazardous or complicated operation requiring skilled labor.

An additional object is to provide a method does not produce any sludge or other hazardous waste. A related object is to provide a method that does not produce any off gases. Yet another object of this invention is to provide a method that is not limited by water and wastewater characteristics such as turbidity, color, or suspended solids. The invention has as a further object providing a method that can be applied as either a pre-treatment or a post-treatment in combination with other water purification processes. Still further, an object of the invention is to provide a method that can be applied to different environmental matrices and work sites.

It is still another object of the present invention to provide a method that can be implemented using reliable equipment. A related object is to provide a method that can be implemented using equipment having a small footprint. Another related object is to provide a method that can be implemented using equipment that is modular in design, such that additional components can be added easily.

### BRIEF SUMMARY OF THE INVENTION

To achieve these and other objects, and in view of its purposes, the present invention provides a method for effectively degrading and destroying many pharmaceutical and personal care compounds in aqueous solutions. The method includes providing an aqueous solution containing at least one pharmaceutical or personal care compound (e.g., estrogene hormone, antibiotics, and the like) to a reactor. A source of ultrasound is provided having a predetermined energy and intensity. The aqueous solution is sonicated in the reactor to degrade and destroy the at least one pharmaceutical or personal care compound. Further provided is a related method for degrading and destroying many pharmaceutical and personal care pollutants in aqueous sludge while simultaneously enhancing the biodegradability and dewaterability of the aqueous sludge. Still further provided is a related method for predicting the first order ultrasound-induced degradation rate constant of any estrogen compound present in an aqueous solution based on the rate constant of estrone.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a graph illustrating the destruction of estrogen compounds in clean water under 2 kW sonolysis (2.06 W/ml), at a pH of 7.0 and individual initial analyte concentration of 10 μg/L;

FIG. 2 is a graph illustrating the pH effects on estrogen destruction under 2.0 kW (2.06 W/ml) sonolysis at a total initial analyte concentration of 50 μg/L;

FIG. 3 depicts the ultrasound-induced reaction processes in an estrogen solution according to an embodiment of the present invention;

FIG. 4 is a graph illustrating the correlation between molecular weight and first order degradation rate constant following sonolysis of a mixture of estrogen compounds in Milli-Q water at an initial analyte concentration of the individual compound of 10 μg/L, an ultrasound density of 2.06 W/ml, and a pH of 7;

FIG. 5 is a graph comparing experimental and predicted destruction of estrogens (using 17 beta-estradiol and 17 alpha ethinyl estradiol as examples) following sonolysis of a mixture of estrogen compounds in Milli-Q water at an initial analyte concentration of the individual compound of 10 μg/L, an ultrasound density of 2.06 W/ml, and a pH of 7;

FIG. 6 is a graph illustrating the decrease in total peak area during sonolysis processes with different ultrasound intensities, with or without temperature control, at an ultrasound density of 1.12 W/ml, an initial analyte concentration of 10 μg/L, and a pH of 7.0;

FIG. 7 is a graph illustrating the destruction of estrogen hormones using horn and probe assemblies to impart ultrasound into the water with tests performed using a 0.6 kW ultrasound unit at 25° C.;

FIG. 8 is a graph illustrating the destruction of estrogen compounds in wastewater under 0.6 kW sonolysis (1.12 W/ml), a pH of 7.0, and an individual initial analyte concentration of 0.5 mg/L;

FIG. 9 is a graph illustrating oxygen consumption rate during BOD tests for sludge before and after sonication; and

FIG. 10 is a graph illustrating volatile suspended solids during aerobic digestion of unsonicated and sonicated sludges.

### DETAILED DESCRIPTION OF THE INVENTION

The present invention generally provides a method of removing pharmaceutical active compounds (PACs), such as estrogen hormones and antibiotics, from aqueous solutions using ultrasound. Ultrasound has been applied for years to clean, enhance distribution, or extract. In recent years, ultrasound irradiation of certain power and frequency has been applied to destroy many organic pollutants in water and wastewater systems. Pharmaceutical and personal care product pollutants are a new environmental concern, however, and the possibility that such pollutants might be destroyed in aqueous systems using ultrasound has not been investigated. Specifically, the removal of estrogen hormones from water and wastewater is of importance due to their adverse effects on the ecosystem and potential risks to human health. Certainly, the optimized treatment units; the configuration of the sonicators, probes, reactors, and controlling systems; and the reaction conditions showing efficient effects have not been investigated.

According to the present invention, an ultrasound source of sufficient intensity and energy (power typically between 0.5 to 4 kW and frequency of about 20 kHz) is applied to destroy pharmaceutical pollutants such as estrogen hormones and antibiotics in water and wastewater. The intensity and energy of the ultrasound source are determined before the source is activated (i.e., predetermined). Used are both a 0.6 and a 2 kW system consisting of piezoelectric material. Both horn and probe tip attachments are used on the sonicator and are immersed into the reaction solution. The water containing pharmaceutical pollutants either flows through the reactor or is placed in a batch reactor. The flow rate is controlled to keep the retention time in the reactor at about 10 to 100 minutes (according to the sonication power and pollutant concentration). The flow-through vessel is made of stainless steel and the probe and horn tips are made of titanium alloy. The aqueous solution is irradiated with ultrasound by switching on the ultrasound. The sonication method is completely based on physical phenomena. No pH adjustment is needed and no other chemicals or materials need to be added to the solution.

The present invention also incorporates an analysis of the effect of operational conditions for a suitable sonication method such as temperature, pH, and pressure. The reaction rate of individual compounds in a mixture of estrogens was investigated. The effect of sonolysis on estrogen degradation in industrial wastewater was also examined.

### EXAMPLES

The present invention is best discussed in the context of experimental examples. The following examples are included to more clearly demonstrate the overall nature of the invention. These examples are exemplary, not restrictive, of the invention.

The estrogen hormones used for purposes of experimentation were obtained from Sigma-Aldrich Co. of St. Louis, Mo.; Steriloids, Inc. of Wilton, N.H.; and from pharmaceutical companies. They were (minimum purities): 17α-estradiol (98%), estrone (100%), estriol (100%), equilin (99.9%), 17α-dihydroequilin (99.4%), 17β-estradiol (97.1%), 17α-ethinyl estradiol (99.1%), gestodene (99.3%), norgestrel (100%), levonorgestrel (100%), 3-O-methyl estrone (used as internal standard, 98%), and medrogestone (99.8%). All solvents were High Performance Liquid Chromatography (HPLC) grade and, along with other chemicals, were purchased from Fisher Scientific Company L.L.C. of Pittsburgh, Pa. Amber glass bottles were also obtained from Fisher Scientific. Varian Bond Elute 3 ml/500 mg solid-phase extraction (SPE) cartridges were obtained from Varian, Inc. of Palo Alto, Calif. All the glassware used for sonication reaction and analysis were silanized as described elsewhere. See, for example, R. Chimchirian et al., “Analysis of low level of free and conjugated synthetic and natural estrogen hormones in water and wastewater,” WEFTEC (Washington, D.C., 2005) (later, “R. Chimchirian et al., ‘Analysis’”). The wastewater was sampled from a pharmaceutical wastewater treatment plant effluent.

Two different sonication reactors, both 20 kHz, were used in this study: a 0.6 kW reactor and a 2 kW reactor. The 0.6 kW unit was used in a batch system in which the solution was kept under ultrasound irradiation for a certain reaction time. The 2 kW unit was used in a continuously flowing reactor in which the solution was passed with a flow rate corresponding to a certain retention time. Horn (45 mm diameter) and probe (10 mm diameter) tip attachments were tested in 250 ml solution in the 0.6 kW system. Approximately 0.28 kW power was applied to the reaction solution, which represents an ultrasound density of 1.12 W/ml. The ultrasound intensities were 18 and 357 W/cm² for the horn and tip assemblies, respectively.

The 2 kW unit had a working volume of 155 ml with the horn attachment (55 mm diameter) and 200 ml with the probe attachment (35 mm diameter). The power applied to the reaction solution was 0.32 kW, which represents ultrasound intensities of 13 and 33 W/cm², and ultrasound densities of 2.06 and 1.60 W/ml, with the horn and probe assemblies, respectively. The flow-through vessel was made of stainless steel and the probe and horn tips were of titanium alloy. Both the 0.6 and 2 kW systems consisted of piezoelectric material. In the temperature-controlled experiments, a water bath was used outside the reactor to keep the temperature of the reaction solution at about 20° C.

The estrogen solution was prepared by spiking a certain volume of stock solution into water purified using a Milli-Q® ultrapure water system available from Millipore Corporation of Billerica, Mass. 200 ml of the solution was sampled periodically and placed into a silanized amber glass bottle. 3-O-methyl estrone was spiked in each sample as the internal standard. The samples were stored in the refrigerator for no more than 24 hours before extraction. The pH of the solutions was adjusted with HNO₃ and NaOH.

The SPE was followed by Gas Chromatography/Mass Spectrometry (or GC/MS) for quantitative analysis of estrogen compounds. In simple terms, a GC/MS instrument represents a device that separates chemical mixtures (the GC component) and a very sensitive detector (the MS component) with a data collector (the computer component). The SPE was preformed using the Varian Bond Elute C-18 adsorbent cartridge. The cartridges were activated using 3 ml of methanol and rinsed with 3 ml of Milli-Q water prior to loading the sample. A 200 ml sample containing the estrogen compounds was passed through the SPE cartridge at a flow rate of 5 ml/min (with a vacuum pump). 3 ml of Milli-Q water was used to rinse the cartridges and then they were eluted with 3 ml of methanol into a test tube. For the wastewater sample, a 3 ml mixture of Milli-Q water and methanol (60:40, v/v) was used to rinse the cartridges in order to prevent interference from the background matrix. The eluent was completely dried using a Genevac EZ-2 personal evaporator and then derivatized by using bis(trimethylsilyl)trifluoro-acetamide for GC/MS analysis. For an explanation of this technique, see R. Chimchirian et al., “Analysis.”

The GC/MS analysis was performed using an Agilent 6890N GC and a 5973N MS. The auto split-less injections were made onto a Pursuit DB-225MS capillary column (30 m×0.25 mm×0.25 μm; J & W Scientific brand available from Agilent Technologies, Inc. of Santa Clara, Calif.) with an initial temperature of 50° C. for 1 minute, and a flow of 4.5 ml/minute, then ramped to 200° C. at 50° C./min with a flow of 4.5 ml/min and held for 45 minutes. Finally, the oven temperature was ramped to 220° C. at 10° C./min and held for 14 minutes. The post run was held at 240° C. for 10 minutes, with a flow of 4.8 mL/min. Helium was used as a carrier gas. The sample injection volume was 4 μl. The inlet and source temperature was 240° C. with a relative source voltage of 1447. The quad was set at 150° C.

Calibration standards were made by spiking appropriate amounts of hormones into 200 ml of Milli-Q water. The coefficient of determination (r²) value was 0.99 or greater for calibration curves. All the data reported were the average of duplicate analyses.

The previous study reported by R. Chimchirian et al., “Analysis,” has shown that, with the above analytical procedure, the recovery efficiencies of all the analytes were higher than 95%, with the exception of ethinyl estradiol and levonorgestrel/norgestrel (levonor/nor). The recovery efficiencies of these two cases were 86% and 81%, respectively. The relative standard deviation (RSD) was less than 2.5% in triplicate analysis. The quantization limit was 0.03 μg/L for all of the compounds using a 200 ml sample, except for equilin, levonorgestrel/norgestrel, and gestodene, in which cases the limits were 4.0 μg/L, 0.87 μg/L, and 0.87 μg/L, respectively. Levonorgestrel and norgestrel were reported together because they co-eluted from the GC column and had the same mass-to-charge ratios.

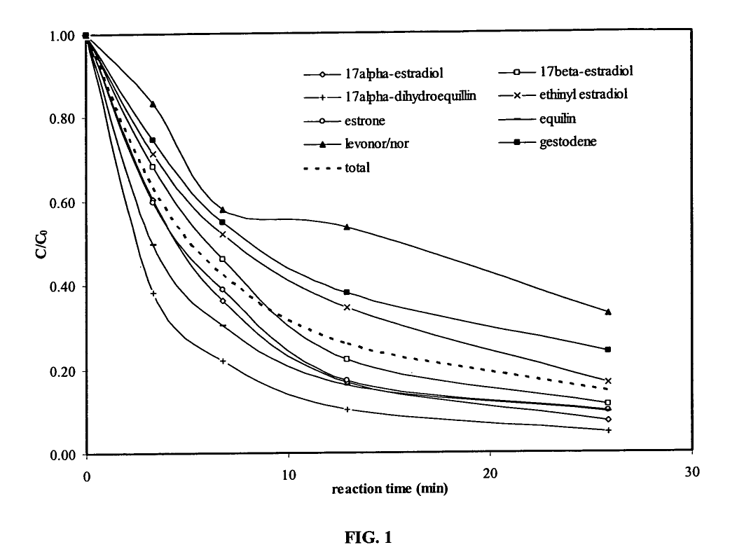

The destruction of estrogen compounds in the Milli-Q water is shown in FIG. 1. FIG. 1 illustrates that, under sonolysis, the estrogen compounds can be significantly removed during a 30 minute reaction. After 25 minutes of sonication, 60 to about 90% of the estrogen compounds were degraded, and about 80% of the estrogens in total were removed. The results indicate that sonolysis, as an advanced oxidation technique, is effective for destruction of estrogens in aqueous systems. The various estrogen compounds have similar structures, but different sites of functional groups, and correspondingly different characteristics, as shown in the Table 1.

TABLE 1
The Estrogen Hormones Selected for Study and Some of Their Properties

| | | Molecular | | Solubility | Henry's Constant |
|---|---|---|---|---|---|
| Compound | CAS # | Weight | Log K_{ow} | (mg/l) | (atm m³/mol) |
| 17α-estradiol | 57-91-0 | 272.4 | 4.01^{a)} | 3.6^{b)} | 3.64 × 10^{-12g)} |
| 17β-estradiol | 50-28-2 | 272.4 | 4.01^{a)} | 3.6^{b)} | 3.64 × 10^{-12g)} |
| 17α-dihydroequilin | 16680- | 270.4 | NA | NA | NA |
| | 48-1 | | | | |
| ethinyl estradiol | 57-63-6 | 296.4 | 3.67^{c)} | 11.3^{a)} | 7.94 × 10^{-12g)} |
| estriol | 50-27-1 | 288.4 | 2.45^{c)} | 441^{e)} | 1.3 × 10^{-12g)} |
| estrone | 53-16-7 | 270.4 | 3.13^{c)} | 30^{f)} | 3.8 × 10^{-10g)} |
| equilin | 474-86-2 | 268.4 | 3.35^{d)} | 1.14^{a)} | NA |
| levonorgestrel | 797-63-7 | 312.5 | 3.48^{d)} | 2.05^{e)} | 7.7 × 10^{-10g)} |
| norgestrel | 6533- | 312.5 | 3.48^{d)} | 1.73^{h)} | 7.7 × 10^{-10g)} |
| | 00-2 | | | | |
| gestodene | 60282- | 310.4 | 3.26^{d)} | 23 | NA |
| | 87-3 | | | | |

^{a)}yalkowski 1992,
^{b)}Hansch 1996,
^{c)}Hansch 1995,
^{d)}Meylan 1995,
^{e)}Meylan 1996,
^{f)}Merck 1996,
^{g)}Meylan 1991,
^{h)}Pinsuwan 1997.
NA: not available.

### FIG. 1 shows that the degradation tendency of the various estrogens differed from each other during sonication in the mixture system.

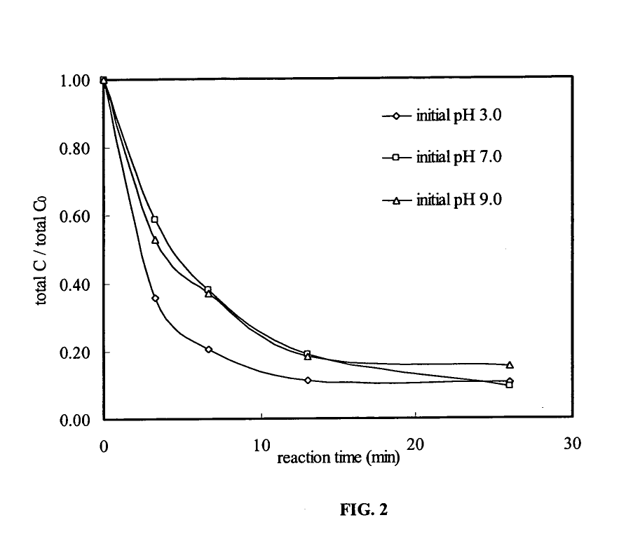

The effect of pH on estrogen degradation in the 2.0 kW sonolysis system was examined with a total initial estrogens concentration of 50 μg/L. The results are shown in FIG. 2. The results indicate that estrogen degradation is affected little by pH. The initial destruction at pH 3 was slightly, but not much, faster than at pH 7 and pH 9. After about 13 minutes, the three pH levels showed similar effects.

The kinetics of sonication of estrogen compounds was studied in the 2.0 kW system with initial individual compound concentrations of 1 and 10 μg/L, and pH levels of 3, 7, and 9. The first or zero-order reaction sonolysis degradation rates of many pollutants have been reported. See Y. Adewuyi, “Sonochemistry: Environmental Science.” It is also reported that the degradation rate constant might be variable with the initial concentration of some pollutants. The first order rate constants tend to decrease, while zero-order rate constants increase, when the initial concentration increases. See Y. Adewuyi, “Sonochemistry: Environmental Science”; see also A. Kotronarou et al., “Oxidation of hydrogen sulfide in aqueous solution by ultrasonic irradiation,” Environmental Science and Technology, 26, pp. 2420-26 (1992). Y. Adewuyi also discussed the change from zero-order to first order degradation rate.

It was observed that the degradation of all estrogen compounds under the tested concentrations and pH could be described with the pseudo first-order kinetics. The pseudo first-order rate constant of each compound under these conditions (including 2.0 kW sonolysis of a mixture of the compounds in Milli-Q water with an ultrasound density of 2.06 W/ml) is shown in Table 2. The order of degradation tendency at pH 7 was: 17α-dihydroequilin>17α-estradiol>equilin>estrone>17β-estradiol>ethinyl estradiol>gestodene>levonorgestrel/norgestrel.

TABLE 2
First-Order Rate Constant of Each Estrogen Compound During Testing

| | First-Order Rate Constant (L/min) | | | |
|---|---|---|---|---|
| | (r²) | | | |
| | 1 μg/L | 10 μg/L | 10 μg/L | 10 μg/L |
| Compound | pH 7.0 | pH 7.0 | pH 3.0 | pH 9.0 |
| 17α-estradiol | 0.1555 | 0.1379 | 0.1679 | 0.1408 |
| | (0.8935) | (0.9972) | (0.9591) | (0.9841) |
| 17β-estradiol | 0.1350 | 0.1161 | 0.1413 | 0.1105 |
| | (0.8977) | (0.9999) | (0.9570) | (0.9902) |
| 17α-dihydroequilin | 0.1721 | 0.1688 | 0.2406 | 0.1298 |
| | (0.8383) | (0.9549) | (0.8040) | (0.9838) |
| ethinyl estradiol | 0.0824 | 0.0815 | 0.1361 | 0.1203 |
| | (0.8475) | (0.9878) | (0.9100) | (0.9653) |
| estrone | 0.1038 | 0.1348 | 0.1588 | 0.1410 |
| | (0.8902) | (0.9984) | (0.9421) | (0.9782) |
| equilin | na | 0.1379 | 0.1820 | 0.1251 |
| | | (0.9696) | (0.8040) | (0.9606) |
| levonorgestrel/ | na | 0.0500 | 0.0902 | 0.0867 |
| norgestrel | | (0.8722) | (0.9337) | (0.9621) |
| gestodene | na | 0.0746 | 0.1082 | 0.1148 |
| | | (0.9880) | (0.9048) | (0.9725) |

na: not available

Table 2 shows that, in the estrogen multi-component system, the reaction rate constant K for the individual estrogen compound does not change significantly with pH or initial concentration in the range of 1 to 10 μg/L. For example, at pH levels of 3, 7, and 9, the first-order rate constant for 17α-estradiol was 0.17, 0.14, and 0.14 per minute, respectively, for an initial concentration of 10 μg/L. When its initial concentration decreased from 10 to 1 μg/L at pH 7, the first-order rate constant changed from 0.14 to 0.15 per minute. From the results in Table 2, it can be determined that the average of the rate constants for all estrogens at 1 μg/L initial concentration was 0.13±0.04 per minute at pH-7. The average of the rate constants for all estrogens at 10 μg/L initial concentration were 0.17±0.07, 0.11±0.06, and 0.11±0.03 per minute at pH levels of 3, 7, and 9, respectively.

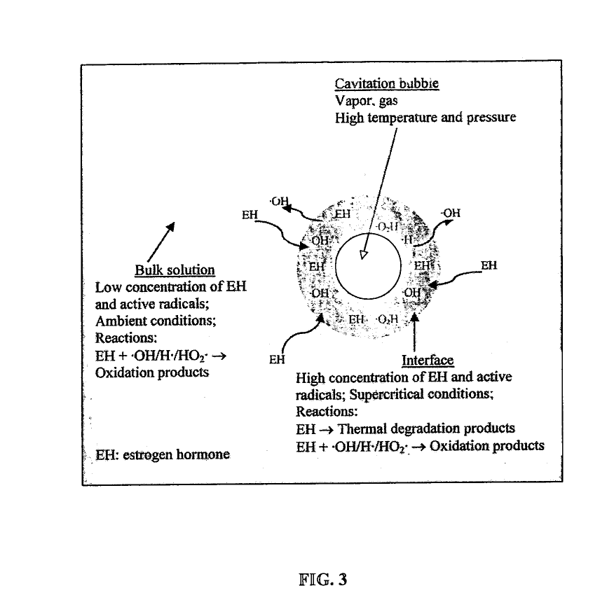

FIG. 3 shows the possible reaction processes in the ultrasound-irradiated estrogen solution. The low Henry's constant for estrogen compounds examined in this study, listed in Table 1, implies insignificant volatilization into the cavity during the process. So the pyrolytic reaction mechanisms inside the cavity are not important. Due to the hydrophobicity of the compounds (low solubility as shown in Table 1), the compounds diffuse into the cavity-liquid interface. The supercritical environment produced in the interfacial region would increase the solubility of estrogens. See Y. Adewuyi, “Sonochemistry: Environmental Science,” and M. Hoffmann et al., “Application of Ultrasonic Irradiation.” Therefore, the reaction likely takes place in the interfacial region where high temperature and pressure are produced on cavity implosion. This allows favorable thermal degradation or supercritical oxidation in the interfacial region during cavity collapse. In addition, the oxidative degradation by the strong radicals in or near the interface is also possible. The oxidative reaction with the radical oxidants in the bulk solution would be minimal.

The octanol-water partition coefficient, Kow, is the ratio of the concentration of a chemical in octanol and in water at equilibrium and at a specified temperature. Octanol is an organic solvent that is used as a surrogate for natural organic matter. This parameter is used in many environmental studies to help determine the fate of chemicals in the environment. An example would be using the coefficient to predict the extent a contaminant will bioaccumulate in fish. The octanol-water partition coefficient has been correlated to water solubility; therefore, the water solubility of a substance could be used to estimate its Kow.

No good correlation (r² higher than 0.8) was observed between rate constants and physicochemical properties, seen in Table 1, such as solubility, Kow, and Henry constant. This may be partly due to possible inaccuracies in the literature-reported property data. There have been some concerns about the quality of the basic physicochemical data such as Kow and solubility. See, for example, R. Renner, “The Kow controversy,” Environmental Science and Technology, pp. 411A-413A (2002).

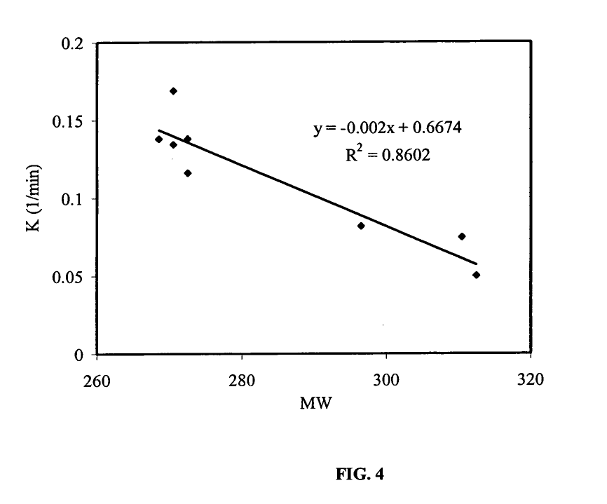

An acceptable correlation between the rate constants (K) and molecular weights (MW) of the estrogens was observed in clean water under the tested conditions, however, and is shown in FIG. 4. FIG. 4 shows that the rate constant decreased with increase in molecular weight. Similar trends were observed for the other reaction conditions (Table 2) in clean water. Such a correlation trend indicates that the ultrasound-induced degradation is slower for bigger molecules. The smaller estrogen compounds can diffuse faster than bigger ones in bulk solution and from there to the interfacial region, and can be more easily degraded thermally.

Estrone is one of the most frequently detected estrogen compounds in natural systems. It can be produced naturally in the body, or from the breakdown of other estrogens. In this study, the ultrasound-induced degradation rate constant of estrone was applied to predict that of the other estrogens. The correlation between rate constant and molecular weight is shown in FIG. 4. Accordingly, a linear regression was determined between the ratio of the rate constant of the estrogen to estrone and the ratio of the molecular weight of the estrogen to estrone, as shown in Equation 1.

K/Kₑₛₜᵣₒₙₑ=a×(MWₑ/MWₑₛₜᵣₒₙₑ)+b (Equation 1)

In Equation 1, K is the rate constant of any estrogen compound and Kₑₛₜᵣₒₙₑ is the experimental rate constant of estrone. MWₑ and MWₑₛₜᵣₒₙₑ are the molecular weights of estrogen and estrone, respectively. Using Equation 1, the first order rate constant of any other estrogen compound during ultrasound-induced degradation can be predicted based on the experimental rate constant of estrone, as shown in Equation 2, in which K_{predict} is the predicted rate constant for any estrogen compound. The values of constants a and b were determined to be −3.9155 and 4.9509, respectively, under pH 7 conditions.

K_{predict}=[a×(MWₑ/MWₑₛₜᵣₒₙₑ)+b]×Kₑₛₜᵣₒₙₑ (Equation 2)

Table 3 lists the predicted rate constant of each estrogen compound, using Equation 2, and the percentage error. The data were generated using sonolysis of a mixture of estrogen compounds in Milli-Q water. The initial concentration of the individual compounds was 10 μg/L, the ultrasound density was 2.06 W/ml, and the pH was 7.

TABLE 3
Predicted First Order Rate Constant, Estrogen Destruction in Water

| | Predicted Rate Constant | Error Percentage |
|---|---|---|
| Compound | (1/min) | (%)* |
| 17α-estradiol | 0.1357 | −1.6 |
| 17β-estradiol | 0.1357 | 16.9 |
| 17α-dihydroequilin | 0.1396 | −17.3 |
| ethinyl estradiol | 0.0888 | 9.0 |
| estrone | 0.1396 | 3.5 |
| equilin | 0.1435 | 4.0 |
| levonorgestrel/norgestrel | 0.0574 | 14.8 |
| gestodene | 0.0615 | −17.6 |

*calculated by [(K_{predicted} − Kₑₓₚₑᵣᵢₘₑₙₜₐₗ)/Kₑₓₚₑᵣᵢₘₑₙₜₐₗ] × 100%

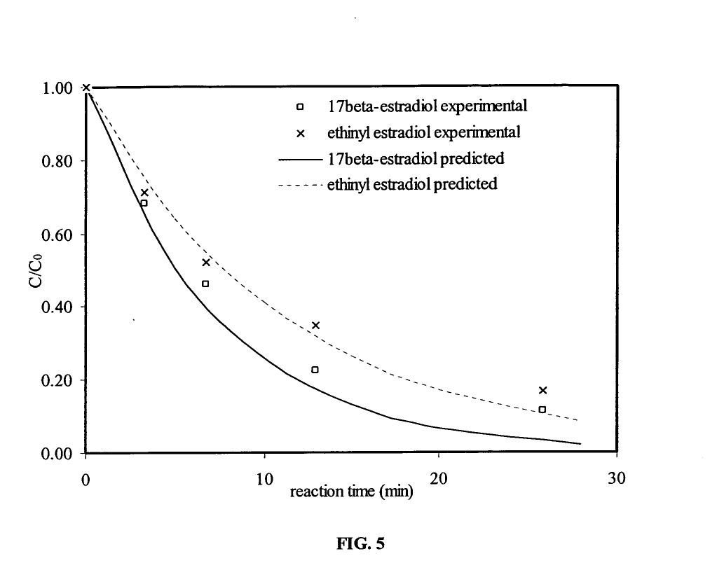

Table 3 shows that the predicted data were quite close to the experimental data. The error was not more than 18%, indicating the effectiveness of a prediction method using molecular weights. In FIG. 5, the experimental and predicted degradation were compared, for 17-β estradiol, an important natural estrogen frequently detected in ecosystems, as well as ethinyl estradiol, an important synthetic estrogen. Hence, the rate data of estrone can be used to predict the degradation of other estrogen compounds.

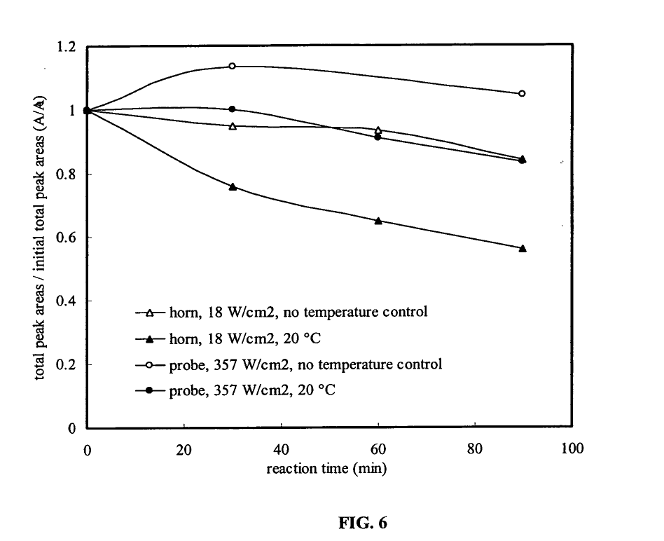

Due to cavitation effects, the temperature of the solution can increase in batch systems during the sonolysis process if there is no temperature control. Under 0.6 kW sonolysis in the batch system, the temperature of the solution reached 85° C. from 20° C. in 30 minutes with a horn attachment, and reached 37° C. in 30 minutes with a probe attachment, absent temperature control. FIG. 6 shows the decrease in total peak area on GC/MS for all compounds, indirectly indicating the degradation during reaction in the solution with or without temperature control, and under different ultrasound intensity.

FIG. 6 indicates that, without temperature control, the decrease in total peak area was less than that at lower temperature. Thus, higher temperature is not favorable for degradation of estrogen compounds in sonolysis. This adverse effect of temperature on the relevant sonolysis reactions, unlike most other chemical reactions, has been confirmed by other researchers. See Y. Adewuyi, “Sonochemistry: Environmental Science,” and M. Entezari et al., “Effect of frequency on sonochemical reactions II. Temperature and intensity effects,” Ultrasonics Sonochemistry, 3, pp. 19-24 (1996). The vapor pressure of the solvent rises as temperature increases. A higher solvent vapor pressure allows more solvent vapor to occupy the cavity interior and results in less violent cavity collapse. By controlling the temperature of the reaction solution, the solvent vapor pressure can be reduced and the intensity of cavity collapse increased.

The horn-attached system has a higher surface area and correspondingly lower ultrasound intensity (18 W/cm²) compared with the probe-attached system (357 W/cm²). FIG. 6 shows that the horn-attached system achieved a higher destruction effect on the estrogen compounds than the probe-attached system. Therefore, the horn-attached sonolysis reactors that have comparatively lower ultrasound intensity were applied in the studies with the temperature controlled at about 20° C.

The application of a probe versus horn assembly was evaluated for transferring the ultrasound energy into the water for both 0.6 and 2 kW sonicator units. Batch experiments were performed with a 0.6 kW unit operating at 20 kHz; the unit delivered between 130 to 140 watts to the solution containing estrogens. Horn (45 mm) and a probe (10 mm) tip attachments were tested in 250 ml solution with the 0.6 kW system, and the results were compared. Approximately 0.28 kW power was imparted to the reaction solution, which represents an ultrasound density of 1.12 W/ml. The ultrasound intensities were 18 and 357 W/cm² for the horn and probe assemblies, respectively.

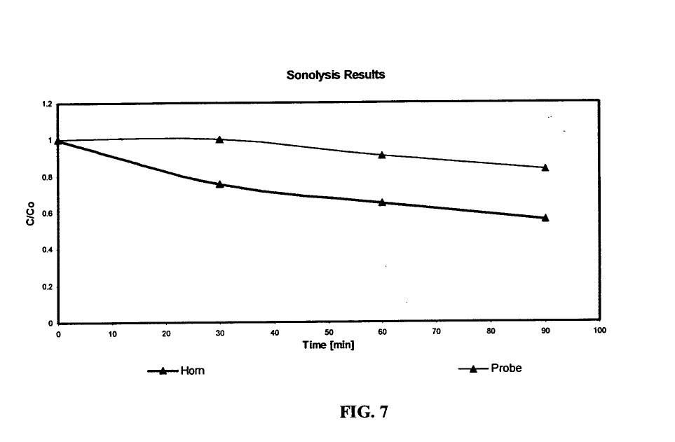

FIG. 7 shows that the horn assembly provided higher destruction of the estrogens as compared to that using the probe assembly. The horn system had a higher surface area and correspondingly lower ultrasound intensity (18 W/cm²) as compared to the probe attachment (357 W/cm²). Typically, the literature teaches that higher ultrasound intensity results in higher chemical destruction. See, for example, F. Wang et al., “Mechanisms and kinetics models for ultrasonic waste activated sludge disintegration,” Journal of Hazardous Materials, 123(1-3), pp. 145-50 (2005). The horn system is also more efficient in terms of power usage than the probe for estrogen destruction. It appears that the geometry of the horn, its higher surface area, and better ultrasound usage efficiency provide better estrogen destruction results.

The effect of fluid pressure on degradation was tested in the 2 kW system where the pressure in the flow-through vessel was increased from 0 to 30 psig by manipulating the hydraulic system. The higher fluid pressure had an adverse effect on degradation of the compounds. The first reason may be due to the retarded cavitation effects. An increase in pressure within the system would require more energy to create a cavity, as may be determined from Equation 3, and cause lower frequency or efficiency of bubble formation. See Y. Adewuyi, “Sonochemistry: Environmental Science.”

I=Pa²/2ρc (Equation 3)

In Equation 3, I represents the acoustic intensity (W/cm²), Pa is the acoustic pressure (pressure in the bubble at the moment of transient collapse), ρ is the density of the fluid (water in this study), and c is the speed of sound in the fluid (1500 m/s in water). The term ρc reflects the acoustic impedance of the medium and is 1.5×10⁶ kg/m²s. At higher fluid pressure, Pa increases and higher ultrasound intensity is needed to achieve cavity collapse.

A second possible reason why higher fluid pressure had an adverse effect on degradation of the compounds is that, with the flow rates that were used, the increase in transferred power also increased the solution temperature which is detrimental to the reaction rate as stated earlier. Specifically, with the fluid pressure at 30 psig, the temperature of the system increased to nearly 40° C.

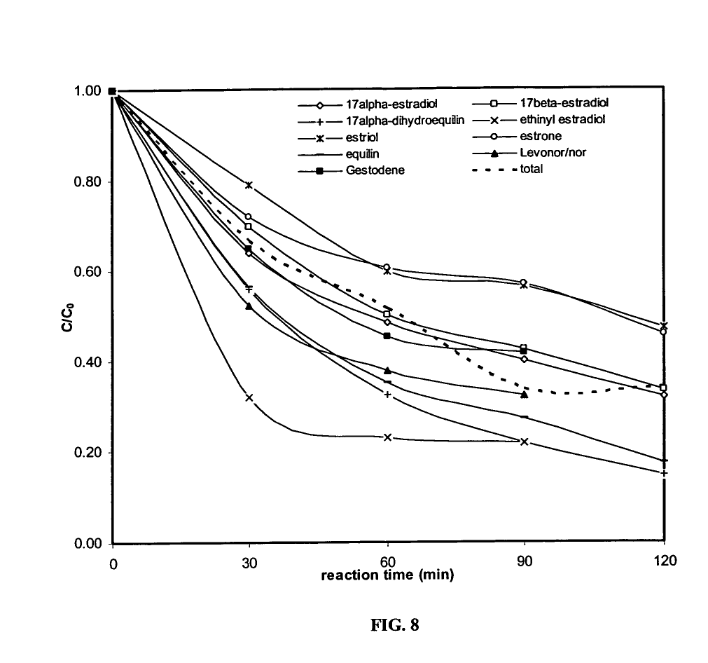

The destruction of estrogen hormones in wastewater was also examined using a 0.6 kW sonolysis system. In this study, the estrogen compounds were spiked into a pharmaceutical wastewater, which was then irradiated with ultrasound. FIG. 8 shows the degradation of each compound in the wastewater. Under a high initial concentration of about 500 μg/L of each compound, the estrogen removal ranged from 40 to 70% in 1 hour of reaction time. Table 4 shows the pseudo first-order rate constant of each estrogen compound in the wastewater. The initial concentration of the individual compounds was 500 μg/L, the ultrasound density was 1.12 W/ml, and the pH was 7. The order of degradation tendency in the wastewater was: 17α-dihydroequilin>equilin>ethinyl estradiol>levonorgestrel/norgestrel>gestodene>17α-estradiol=17β-estradiol>estriol=estrone. This order of degradation in the wastewater was somewhat different from that in the clean water.

TABLE 4
First Order Rate Constant, Estrogen Destruction in Wastewater

| | First-Order Rate Constant |
|---|---|
| Compound | (L/min) (r²) |
| 17α-estradiol | 0.0092 (0.9684) |
| 17β-estradiol | 0.0090 (0.9801) |
| 17α-dihydroequilin | 0.0159 (0.9910) |
| ethinyl estradiol | 0.0132 (0.9166) |
| estrone | 0.0060 (0.9455) |
| equilin | 0.0141 (0.9851) |
| levonorgestrel/norgestrel | 0.0124 (0.9185) |
| gestodene | 0.0100 (0.9324) |
| estriol | 0.0061 (0.9615) |

Table 4 shows that, in the wastewater system with higher initial concentration, the reaction rate was slower than that in the clean water systems with lower initial concentration. This may result from lower ultrasound power, higher estrogen concentration, and the matrix effects in the wastewater samples. The reaction was also slower due to possible interference of the accumulated by-products in the system. Furthermore, the presence of many other organic and inorganic chemicals (unidentified) may create competition for free radicals. The competition may not affect each estrogen identically. Therefore, matrix effects may be important and should be considered when evaluating sonication for use in wastewater treatment systems.

The average of first-order rate constants of all estrogens in the wastewater was 0.011±0.005 per minute, which was only 10% the average of the rate constant observed in clean water. Moreover, the difference (deviation of 0.005 per minute) among the reaction rate constants in wastewater at higher initial concentration was insignificant when compared to the clean water systems (deviation of 0.06 per minute) at pH 7 with 10 μg/L initial concentration. It may be possible to enhance degradation rate with higher-power ultrasound systems.

In summary, a sonication method as defined by the present invention is an effective method for removal of estrogen hormones in aqueous system. The ultrasound-induced destruction of estrogen compounds in aqueous solutions was studied in a batch reactor using a 1.12 W/ml sonication unit and in a continuous flow reactor using a 2.06 W/ml sonication unit. The degradation of the compounds can be simulated with the pseudo first-order reaction in both clean water and wastewater. The order of degradation tendency at pH 7 in clean water was: 17α-dihydroequilin>17α-estradiol>equilin>estrone>17β-estradiol>ethinyl estradiol>gestodene>levonorgestrel/norgestrel. The average rate constants at 10 μg/L initial concentration were 0.17±0.07, 0.11±0.06, and 0.11±0.03 per minute at pH 3, 7, and 9, respectively.

No significant change in degradation rate constant occurred for different initial analyte concentrations of 1 μg/L or 10 μg/L. The degradation rate constant decreased slightly with molecular weight increase. Accordingly, the destruction of estrogens can be predicted, with acceptable agreement, based on the experimental degradation of estrone. Higher solution temperatures and fluid pressures were detrimental to destruction efficiencies. The order of degradation tendency in wastewater was somewhat different from that in clean water, probably due to high estrogen concentration and matrix effects in wastewater samples. The order of degradation tendency of estrogens in wastewater is 17α-dihydroequilin>equilin>ethinyl estradiol>levonorgestrel/norgestrel>gestodene>17α-estradiol=17β-estradiol>estriol=estrone. The average first-order rate constants of all estrogens in the wastewater under 0.6 kW sonolysis was 0.011±0.005 per minute.

### Example Applications

The ultrasound method according to the present invention has a number of practical applications. For purposes of illustration, and without limitation, a number of those applications are highlighted below.

The method can be used to destroy PPCPs in water and wastewater systems, including surface water, groundwater, raw drinking water, municipal wastewater, and industrial wastewater (hospital, pharmaceutical). More specifically, the ultrasound method can efficiently decontaminate (e.g., destroy estrogen hormones in) high strength and small volume wastewaters at hospitals, nursing homes, and pharmaceutical production plants where the wastewater containing hormones and pharmaceuticals is initially generated. It can also be used to destroy natural hormones present in the wastewater generated at the International Space Station where the goal is to capture and recycle all the fluid excreted from the human body.

The method can be applied during drinking water treatment procedures to remove any PPCPs in the water source, especially those PPCPs that cannot be removed with conventional drinking water treatment methods. The method can be applied for drinking water purification to remove trace level estrogen compounds that have potential adverse effects on human health. Thus, the method can remove trace levels of pharmaceutical contaminants from drinking water.

With the application of the method, release of pharmaceutical pollutants from pharmaceutical industries and municipal wastewater treatment plants and other sources can be minimized if not eliminated. The ultrasound method of destroying hormones can also be used as a supplement to other existing conventional (e.g., municipal) wastewater treatment techniques, either pre-treatment to remove toxic compounds to favor biodegradation, or post-treatment to remove environmental unfriendly chemicals before the effluent enters receiving water bodies or is reused for irrigation. More specifically, the method can be applied as the post-treatment after conventional biological treatment units to remove any remaining PPCPs in the system.

The method can be applied prior to conventional biological units during industrial and municipal wastewater treatment for PPCPs destruction. It is of benefit to remove the targeted pharmaceutical compounds from the wastewater influent, to desorb the adsorbed PPCPs from solid particles, and to degrade the toxic or high strength PPCP compounds to smaller molecules that have enhanced bio-degradability for the following bio-treatment steps. In addition, treatment of the influent stream will prevent the sorption of PPCPs to the biosolids (sludge). Hence, the production of contaminated sludge can be prevented.

An important potential application observed from experiments conducted is that the ultrasound method has the ability to destroy chemicals that are sorbed onto contaminated sludge in wastewater. Hence, the method can be used to clean contaminated sludge in wastewater treatment plants. Data show that a pharmaceutical compound sorbed to (“stuck on”) wastewater sludge can be destroyed using the ultrasound method, i.e., the sludge can be “cleaned” by destroying the sorbed contaminant with ultrasound.

To test experimentally whether ultrasound helps in the degradation of the pharmaceutical compound hexachlorophene (HXC) present in sludge, the solid and liquid phases of sludge were analyzed individually both before and after the application of ultrasound. Sludge was initially spiked with HXC and a part of the sludge was taken for unsonicated sludge tests (i.e., dry suspended solid, or DSS, concentration) and analysis of the concentration of HXC in the two phases of the unsonicated sludge. The solid and liquid phases from the unsonicated sludge were analyzed. The remaining spiked sludge was sonicated. After 90 minutes of sonication, the sonicated sludge was analyzed for DSS and HXC concentration in a similar manner as done for the unsonicated sludge.

Sludge contaminated with HXC was treated with ultrasound, and the results are shown in Table 5. The amount of contaminant sorbed onto the sludge before and after the sonication process was measured. The experiment was conducted twice to test the reproducibility of the experiment. The results are reproducible because the percentage of the pharmaceutical compound removed is 74 to 82%. Results show that the mass of the contaminant in the sludge (liquid and solid phases combined) dropped by 70-80%, showing the degradation effect of ultrasound on contaminant present in the sludge.

TABLE 5
Mass Balance for HXC and % Removal from Sludge by Ultrasound

| | | HXC | HXC | | | |
|---|---|---|---|---|---|---|
| | | concentration | concentration | | Total | |
| | | in liquid phase | in solid phase | Dry solid | HXC | HXC removal |
| Expt. | Sludge | (μg/L) | (μg/g DS) | (g/L) | (μg/L) | (%) |
| 1 | Before | 83.13 | 4669.66 | 2.65 | 12453.56 | 82 |
| | sonication | | | | | |
| | After | 1495.27 | 863.76 | 0.90 | 2253.96 | |
| | sonication | | | | | |
| 2 | Before | 83.39 | 547.82 | 16.49 | 9114.08 | 74 |
| | sonication | | | | | |
| | After | 1272.63 | 706.51 | 1.66 | 2413.61 | |
| | sonication | | | | | |

Along with the destruction of the pharmaceutical compound in the sludge, a side outcome observed was the enhancement in the biodegradability and dewaterability of the sludge. This may be observed from Table 5, column 5, as the amount of solids in the sludge reduced tremendously after sonication. This result suggests the feasibility of a sludge-less reactor. Because sludge disposal is a costly problem, minimizing the sludge to almost zero sludge would be a positive direction in the reduction of operational costs in wastewater treatment facilities.

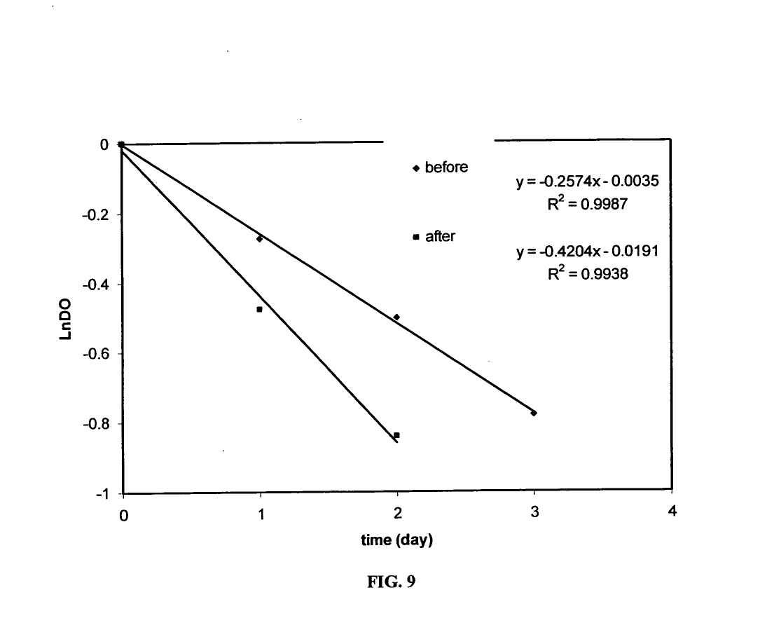

Biological oxidation demand (BOD) tests on the unsonicated and sonicated sludge were also performed. BOD commonly serves as a measure of pollution. From BOD tests completed for sludge before and after sonication, FIG. 9 shows that the oxygen consumption rate for sonicated sludge was faster (higher slope) than that for unsonicated sludge after a 3-day period of the BOD test. This result indicates that the sonicated sludge can be biodegraded more quickly. A faster removal of BOD indicates that the pollution source is being removed faster.

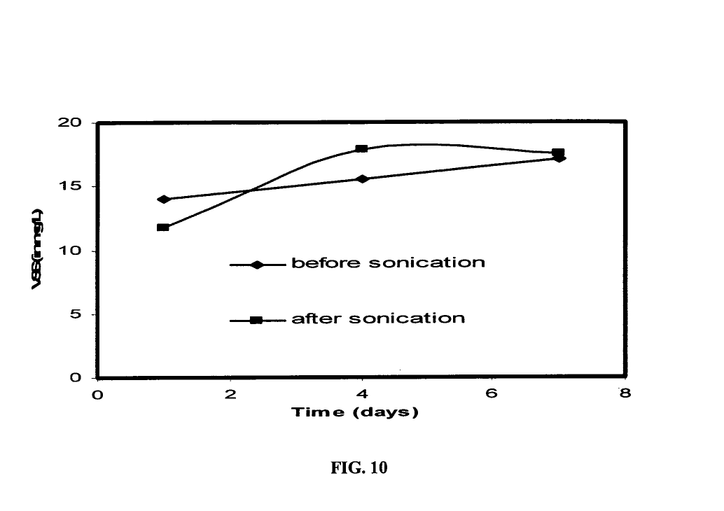

The volatile suspended solids (VSS) during aerobic processes of unsonicated and sonicated sludge were also measured. VSS indicates the biodegradable fraction of the sludge. Higher VSS content indicates the higher bacteria activity and higher degradability of the background pollutants. From VSS tests completed in similar aerobic reactors for sludge before and after sonication, FIG. 10 shows that the VSS content is higher in the sonicated sample after 4 days as compared to that for the unsonicated sample. This result implies that sonicated sludge can be placed in a bioreactor and easily biodegraded by the bacteria (the result is faster bacteria growth and higher VSS content values). Hence, sonication increased the biodegradability of the sludge. The data also indicate that the desirable effects of ultrasound are not undermined by suspended particles.

There have been some recent studies reported by others regarding application of ultrasound in improving the biodegradability of sludge and zero sludge reactors. As to the former, see P. Marjoleine et al., “Evaluation of current wet sludge disintegration techniques,” Journal of Chemical Technology & Biotechnology, 73(2), pp. 83-92 (1998); and U. Neis, “Ultrasound in water, wastewater and sludge treatment,” Water 21, 4, pp. 36-39 (2000). As to the latter, see S. Yoon et al., “Incorporation of ultrasonic cell disintegration into a membrane bioreactor for zero sludge production,” Process Biochemistry, 39(12), pp. 1923-29 (2004). There have also been research papers on the application of ultrasound to increase sludge dewaterability, by studying the decrease in capillary suction time of the sludge after the application of ultrasound. See T. Hall, “Sonication induced changes of particle size and their effects on activated sludge dewaterability,” Environmental Technology Letters, 3, pp. 79-88 (1982); and X. Yin et al., “A review on the dewaterability of bio-sludge and ultrasound pretreatment,” Ultrasonics Sonochemistry, 11(6), pp. 337-48 (2004).

The experimental data outlined above support an improvement, however, namely the simultaneous benefit of “cleaning” or decontaminating the sludge by destroying the pharmaceutical contaminants, while converting the sludge into a form which is easily biodegradable. This process of ultrasound is applicable to decontaminate sludge or sediments generated from drinking water, municipal wastewater, and industrial wastewater treatment plants.

### Example Advantages

In addition to the advantages outlined above for the ultrasound method according to the present invention, among the other advantages are:

a. The method is simple to use. The user simply activates (typically, using a switch) the reactor to treat the water. There is no hazardous or complicated operation requiring skilled labor. Thus, the method can be easily operated with immediate on/off by central control.

b. The equipment necessary to implement the method is reliable.

c. The equipment necessary to implement the method has a small footprint and is modular in design, such that additional units can be added easily. Unlike some other methods, the implementing equipment does not need much space. Instead, the method is very convenient to apply in small areas such as in hospitals and pharmaceutical manufacturing rooms where the estrogen-contaminated wastewater is first generated.

d. The method provides a high destruction effect on toxic and highly potent pharmaceutical and personal care chemicals and, more specifically, can destroy a variety of different estrogen hormones.

e. The method does not require any chemical additives.

f. The method does not require any pH adjustment.

g. The method does not require any filtration.

h. The method does not produce any waste sludge. This is a major advantage over biological processes which generate sludge that mandates disposal—generally as hazardous waste.

i. The method does not produce any off gases. This is a major advantage over processes such as those using ozone in which the unused ozone in the off-gas must be destroyed and the residual ozone in the treated water must be removed.

j. The method is not limited by water and wastewater characteristics such as turbidity, color, or suspended solids.

k. The method can be applied as either a pre-treatment or a post-treatment in combination with other water purification processes.

l. It is feasible to apply the method to different environmental matrices and work sites.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

What is claimed:

1. A method for effectively degrading and destroying many pharmaceutical and personal care compounds in aqueous solutions comprising:
providing an aqueous solution containing at least one pharmaceutical or personal care compound to a reactor;
providing a source of ultrasound having a predetermined energy and intensity; and
sonicating the aqueous solution in the reactor to degrade and destroy the at least one pharmaceutical or personal care compound.

2. The method according to claim 1 wherein the power of the ultrasound is between approximately 0.5 and 4 kW.

3. The method according to claim 1 wherein the reaction time of the aqueous solution in the reactor is between approximately 10 and 100 minutes.

4. The method according to claim 1 wherein the temperature of the reactor is controlled at approximately 20° C.

5. The method according to claim 1 wherein the at least one pharmaceutical or personal care compound is estrogen.

6. The method according to claim 1 wherein the reactor has a horn tip attachment by which the ultrasound is delivered to the aqueous solution in the reactor.

7. The method according to claim 1 wherein the step of sonication is done without pH control.

8. The method according to claim 1 wherein the step of sonication is done without filtration.

9. The method according to claim 1 wherein no chemicals are added to the aqueous solution.

10. The method according to claim 1 wherein the reactor is a flowing reactor operated under a fluid pressure minimized so as to prevent adverse effect on the step of sonication.

11. The method according to claim 1 further comprising the step of applying, either before or after the step of sonication, a separate, non-ultrasonic aqueous solution treatment technique.

12. The method according to claim 5 wherein the first order ultrasound-induced degradation rate constant of the estrogen is between about 0.05 and 0.25 per minute.

13. A method for degrading and destroying many pharmaceutical and personal care pollutants in aqueous sludge comprising:
providing an aqueous sludge containing at least one pharmaceutical or personal care pollutant to a reactor;
providing a source of ultrasound having a predetermined energy and intensity; and
sonicating the aqueous sludge in the reactor to degrade and destroy the at least one pharmaceutical or personal care pollutant,
wherein the step of sonicating simultaneously enhances the biodegradability and dewaterability of the aqueous sludge.

14. The method according to claim 13 wherein the temperature of the reactor is controlled at approximately 20° C.

15. The method according to claim 13 wherein the at least one pharmaceutical or personal care pollutant is estrogen.

16. The method according to claim 13 wherein the reactor has a horn tip attachment by which the ultrasound is delivered to the aqueous sludge in the reactor.

17. The method according to claim 13 wherein the step of sonication is done without pH control, without filtration, and without the addition of chemicals to the aqueous sludge.

18. A method for predicting the first order ultrasound-induced degradation rate constant of any estrogen compound present in an aqueous solution based on the rate constant of estrone, the method comprising:
determining experimentally the first order ultrasound-induced degradation rate constant of estrone in the aqueous solution;
obtaining the molecular weight of the estrogen compound and of estrone; and
calculating the first order ultrasound-induced degradation rate constant of the estrogen compound based on the first order ultrasound-induced degradation rate constant of estrone, the molecular weight of the estrogen compound, and the molecular weight of estrone.

19. The method according to claim 18 wherein the step of calculating is performed according to the equation: rate constant of the estrogen compound equals [a×(MWₑ/MWₑₛₜᵣₒₙₑ)+b]×Kₑₛₜᵣₒₙₑ, where MWₑ and MWₑₛₜᵣₒₙₑ are the molecular weights of the estrogen compound and estrone, respectively, a and b are constants, and Kₑₛₜᵣₒₙₑ is the first order ultrasound-induced degradation rate constant of estrone.

20. The method according to claim 19 wherein the constant a is approximately −4 and the constant b is approximately 5.
